(19) United States
(12) Patent Application Publication
(10) Pub. No.: US 2024/0406884 A1
(43) Pub. Date: Dec. 5, 2024

(54) BAND-SPECIFIC POWER CONTROL WITH MULTI-BAND ANTENNA MODULES

(71) Applicant: QUALCOMM Incorporated, San Diego, CA (US)

(72) Inventors: Vasanthan RAGHAVAN, West Windsor Township, NJ (US); Sinan ADIBELLI, San Diego, CA (US); Jung Ho RYU, Fort Lee, NJ (US); Mohammad Ali TASSOUDJI, San Diego, CA (US)

(21) Appl. No.: 18/328,576

(22) Filed: Jun. 2, 2023

(51) Int. Cl. H04W 52/36; H04W 8/22

(52) U.S. Cl. CPC H04W 52/362; H04W 8/22

(57) ABSTRACT

Methods, systems, and devices for wireless communications are described. A user equipment (UE) may receive a control message indicating a power scaling parameter dedicated to a frequency subband of a band for wireless communications by an antenna panel at the UE. In some cases, the UE may switch from a second frequency subband of the band to the frequency subband based on receiving the control message, and the UE may switch from a second power scaling parameter associated with the second frequency subband to the power scaling parameter based on switching to the frequency subband. The UE may transmit, by the antenna panel, a signal via the frequency subband at a transmit power that is based on the power scaling parameter dedicated to the frequency subband.

### FIELD OF TECHNOLOGY

The following relates to wireless communications, including band-specific power control with multi-band antenna modules.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In some examples, a UE may transmit signals via a multi-band antenna module.

### SUMMARY

The described techniques relate to improved methods, systems, devices, and apparatuses that support band-specific power control with multi-band antenna modules. For example, the described techniques provide for a user equipment (UE) coordinating with a network entity regarding a power control parameter change. For example, the UE may receive a control message from the network entity indicating a band-specific power control parameter for an operating frequency at the UE, and the UE may transmit a signal via the operating frequency at a transmit power based on the band-specific power control parameter.

A method for wireless communication at a UE is described. The method may include transmitting a capability message indicating an antenna panel at the UE supports a set of multiple frequency subbands of a band, receiving, based on transmitting the capability message, a control message indicating a power scaling parameter dedicated to a frequency subband of the band for wireless communications by the antenna panel at the UE, and transmitting, by the antenna panel, a signal via the frequency subband at a transmit power that is based on the power scaling parameter dedicated to the frequency subband.

An apparatus for wireless communication at a UE is described. The apparatus may include at least one processor, at least one memory coupled with the at least one processor, and instructions stored in the at least one memory. The instructions may be executable by the at least one processor to cause the apparatus to transmit a capability message indicating an antenna panel at the UE supports a set of multiple frequency subbands of a band, receive, based on transmitting the capability message, a control message indicating a power scaling parameter dedicated to a frequency subband of the band for wireless communications by the antenna panel at the UE, and transmit, by the antenna panel, a signal via the frequency subband at a transmit power that is based on the power scaling parameter dedicated to the frequency subband.

Another apparatus for wireless communication at a UE is described. The apparatus may include means for transmitting a capability message indicating an antenna panel at the UE supports a set of multiple frequency subbands of a band, means for receiving, based on transmitting the capability message, a control message indicating a power scaling parameter dedicated to a frequency subband of the band for wireless communications by the antenna panel at the UE, and means for transmitting, by the antenna panel, a signal via the frequency subband at a transmit power that is based on the power scaling parameter dedicated to the frequency subband.

A non-transitory computer-readable medium storing code for wireless communication at a UE is described. The code may include instructions executable by a processor to transmit a capability message indicating an antenna panel at the UE supports a set of multiple frequency subbands of a band, receive, based on transmitting the capability message, a control message indicating a power scaling parameter dedicated to a frequency subband of the band for wireless communications by the antenna panel at the UE, and transmit, by the antenna panel, a signal via the frequency subband at a transmit power that is based on the power scaling parameter dedicated to the frequency subband.

Some examples of the method, apparatuses, and non-transitory computer-readable medium described herein may further include operations, features, means, or instructions for switching from a second frequency subband of the band to the frequency subband based on receiving the control message and switching from a second power scaling parameter associated with the second frequency subband to the power scaling parameter based on switching to the frequency subband.

In some examples of the method, apparatuses, and non-transitory computer-readable medium described herein, the frequency subband may be a higher frequency than the second frequency subband, and the power scaling parameter indicates increasing the transmit power for transmitting the signal relative to the second power scaling parameter.

In some examples of the method, apparatuses, and non-transitory computer-readable medium described herein, the frequency subband may be a lower frequency than the second frequency subband, and the power scaling parameter indicates decreasing the transmit power for transmitting the signal relative to the second power scaling parameter.

In some examples of the method, apparatuses, and non-transitory computer-readable medium described herein, the control message indicates a set of multiple power scaling parameters, each power scaling parameter of the set of multiple power scaling parameters dedicated to a respective frequency subband of the band.

Some examples of the method, apparatuses, and non-transitory computer-readable medium described herein may further include operations, features, means, or instructions for receiving a second control message indicating a modulation and coding scheme (MCS) dedicated to the frequency subband of the band for wireless communications by the antenna panel at the UE and transmitting, by the antenna panel, a second signal via the frequency subband using the MCS dedicated to the frequency subband.

Some examples of the method, apparatuses, and non-transitory computer-readable medium described herein may further include operations, features, means, or instructions for receiving a second control message indicating an offset associated with the power scaling parameter, where transmitting the signal further includes transmitting the signal at a second transmit power based on the offset.

In some examples of the method, apparatuses, and non-transitory computer-readable medium described herein, the second transmit power may be less than the transmit power.

Some examples of the method, apparatuses, and non-transitory computer-readable medium described herein may further include operations, features, means, or instructions for receiving a second control message indicating one or more interference measurements based on receiving the control message and determining an offset associated with the power scaling parameter based on receiving the second control message, where transmitting the signal further includes transmitting the signal at a second transmit power based on the offset.

In some examples of the method, apparatuses, and non-transitory computer-readable medium described herein, the second control message includes an indication of one or more grating lobes, the one or more grating lobes based on transmitting the signal via the frequency subband at the transmit power.

In some examples of the method, apparatuses, and non-transitory computer-readable medium described herein, the control message includes an uplink control information (UCI) message or a medium access control-control element (MAC-CE) message.

A method for wireless communication at a network entity is described. The method may include receiving a capability message indicating an antenna panel at a UE supports a set of multiple frequency subbands of a band, transmitting, based on receiving the capability message, a control message indicating a power scaling parameter dedicated to a frequency subband of the band for wireless communications by the antenna panel at the UE, and receiving, from the antenna panel, a signal via the frequency subband at a transmit power that is based on the power scaling parameter dedicated to the frequency subband.

An apparatus for wireless communication at a network entity is described. The apparatus may include at least one processor, at least one memory coupled with the at least one processor, and instructions stored in the at least one memory. The instructions may be executable by the at least one processor to cause the apparatus to receive a capability message indicating an antenna panel at a UE supports a set of multiple frequency subbands of a band, transmit, based on receiving the capability message, a control message indicating a power scaling parameter dedicated to a frequency subband of the band for wireless communications by the antenna panel at the UE, and receive, from the antenna panel, a signal via the frequency subband at a transmit power that is based on the power scaling parameter dedicated to the frequency subband.

Another apparatus for wireless communication at a network entity is described. The apparatus may include means for receiving a capability message indicating an antenna panel at a UE supports a set of multiple frequency subbands of a band, means for transmitting, based on receiving the capability message, a control message indicating a power scaling parameter dedicated to a frequency subband of the band for wireless communications by the antenna panel at the UE, and means for receiving, from the antenna panel, a signal via the frequency subband at a transmit power that is based on the power scaling parameter dedicated to the frequency subband.

A non-transitory computer-readable medium storing code for wireless communication at a network entity is described. The code may include instructions executable by a processor to receive a capability message indicating an antenna panel at a UE supports a set of multiple frequency subbands of a band, transmit, based on receiving the capability message, a control message indicating a power scaling parameter dedicated to a frequency subband of the band for wireless communications by the antenna panel at the UE, and receive, from the antenna panel, a signal via the frequency subband at a transmit power that is based on the power scaling parameter dedicated to the frequency subband.

In some examples of the method, apparatuses, and non-transitory computer-readable medium described herein, the control message includes an indication to switch from a second frequency subband of the band to the frequency subband and to switch from a second power scaling parameter associated with the second frequency subband to the power scaling parameter.

In some examples of the method, apparatuses, and non-transitory computer-readable medium described herein, the frequency subband may be a higher frequency than the second frequency subband, and the power scaling parameter indicates increasing the transmit power for transmitting the signal relative to the second power scaling parameter.

In some examples of the method, apparatuses, and non-transitory computer-readable medium described herein, the frequency subband may be a lower frequency than the second frequency subband, and the power scaling parameter indicates decreasing the transmit power for transmitting the signal relative to the second power scaling parameter.

In some examples of the method, apparatuses, and non-transitory computer-readable medium described herein, the control message indicates a set of multiple power scaling parameters, each power scaling parameter of the set of multiple power scaling parameters dedicated to a respective frequency subband of the band.

Some examples of the method, apparatuses, and non-transitory computer-readable medium described herein may further include operations, features, means, or instructions for transmitting a second control message indicating an MCS dedicated to the frequency subband of the band for wireless communications by the antenna panel at the UE and receiving, by the antenna panel, a second signal via the frequency subband based on the MCS dedicated to the frequency subband.

Some examples of the method, apparatuses, and non-transitory computer-readable medium described herein may further include operations, features, means, or instructions for transmitting a second control message indicating an offset associated with the power scaling parameter, where receiving the signal further includes receiving the signal at a second transmit power based on the offset.

In some examples of the method, apparatuses, and non-transitory computer-readable medium described herein, the second transmit power may be less than the transmit power.

Some examples of the method, apparatuses, and non-transitory computer-readable medium described herein may further include operations, features, means, or instructions for transmitting a second control message indicating one or more interference measurements based on transmitting the control message, where receiving the signal further includes receiving the signal at a second transmit power based on the one or more interference measurements.

In some examples of the method, apparatuses, and non-transitory computer-readable medium described herein, the second control message includes an indication of one or more grating lobes, the one or more grating lobes based on receiving the signal via the frequency subband at the transmit power.

In some examples of the method, apparatuses, and non-transitory computer-readable medium described herein, the control message includes a UCI or a MAC-CE message.

### BRIEF DESCRIPTION OF THE DRAWINGS

FIG. 1 shows an example of a wireless communications system that supports band-specific power control with multi-band antenna modules in accordance with one or more aspects of the present disclosure.

FIG. 2 shows an example of a wireless communications system that supports band-specific power control with multi-band antenna modules in accordance with one or more aspects of the present disclosure.

FIGS. 3A and 3B show examples of beam property graphs that support band-specific power control with multi-band antenna modules in accordance with one or more aspects of the present disclosure.

FIG. 4 shows an example of a process flow that supports band-specific power control with multi-band antenna modules in accordance with one or more aspects of the present disclosure.

FIGS. 5 and 6 show block diagrams of devices that support band-specific power control with multi-band antenna modules in accordance with one or more aspects of the present disclosure.

FIG. 7 shows a block diagram of a communications manager that supports band-specific power control with multi-band antenna modules in accordance with one or more aspects of the present disclosure.

FIG. 8 shows a diagram of a system including a device that supports band-specific power control with multi-band antenna modules in accordance with one or more aspects of the present disclosure.

FIGS. 9 and 10 show block diagrams of devices that support band-specific power control with multi-band antenna modules in accordance with one or more aspects of the present disclosure.

FIG. 11 shows a block diagram of a communications manager that supports band-specific power control with multi-band antenna modules in accordance with one or more aspects of the present disclosure.

FIG. 12 shows a diagram of a system including a device that supports band-specific power control with multi-band antenna modules in accordance with one or more aspects of the present disclosure.

FIGS. 13 through 19 show flowcharts illustrating methods that support band-specific power control with multi-band antenna modules in accordance with one or more aspects of the present disclosure.

### DETAILED DESCRIPTION

In some wireless communications systems, a user equipment (UE) may utilize a multi-band antenna module to support multiple frequency subbands of a millimeter wave band (e.g., different bands within frequency range 2 (FR2) such as n260, n257, n258, etc.). However, the inter-antenna element spacing for the multi-band antenna module may remain the same, even as an operating frequency/subband of the UE changes. As the frequencies change, the spacing between antenna elements (as a function of wavelength associated with the carrier frequency) may change. For example, a multi-band antenna module may include antenna elements spaced apart by a distance that is fixed. At a first frequency, the distance between antenna elements may be expressed as 0.671, where A represents the wavelength at the first frequency. At a second frequency, the distance between antenna elements may be expressed as 0.812, where A represent the wavelength at the second frequency. Such conditions may cause changes to beam properties across different frequencies/subbands that are transmitted by the multi-band antenna module. For example, elemental gain droop may increase as beams are directed at a greater angle with respect to the boresight direction. The elemental gain droop for such beams may negatively impact UE performance and reduce reliability of communications in the affected frequency/subband. Additionally, the elemental gain droop may interfere with communications at other frequencies/subbands or communications transmitted or received in other directions.

In some examples, a wireless communications system may utilize band-specific power scaling parameters. For example, a network entity may indicate a power scaling parameter dedicated to a frequency/subband of the millimeter wave band for communication by the multi-band antenna module at a UE. The network entity may schedule the UE (e.g., for uplink transmissions), and the UE may apply the power scaling parameter to transmissions via the operating frequency/subband that is scheduled. In some examples, the UE may transmit capability information indicating that the UE supports a multi-band antenna module, and the network entity may indicate the band-specific power scaling parameter to the UE based on the capability information. In some cases, the network entity may indicate a modulation and coding scheme (MCS) for the operating frequency/subband. The UE may use the MCS for transmissions in the operating frequency/subband to mitigate interference.

By using band-specific power scaling parameters, the UE may support increased reliability of communications by transmitting signals at a sufficient power. For example, elemental gain droop may, in some cases and at some frequencies, cause a network entity to receive signals from a UE 115 with error, or the network entity may fail to receive the signals due to insufficient power. The UE may increase a transmit power for signals at some frequencies/bands, such as frequency bands highly impacted by elemental gain droop, which may support increased reliability of communications between the UE and the network entity at those frequencies without a drop in power or loss of data.

Aspects of the disclosure are initially described in the context of wireless communications systems. Aspects of the disclosure are further described in the context of wireless communications systems, beam property graphs, and process flows. Aspects of the disclosure are further illustrated by and described with reference to apparatus diagrams, system diagrams, and flowcharts that relate to band-specific power control with multi-band antenna modules.

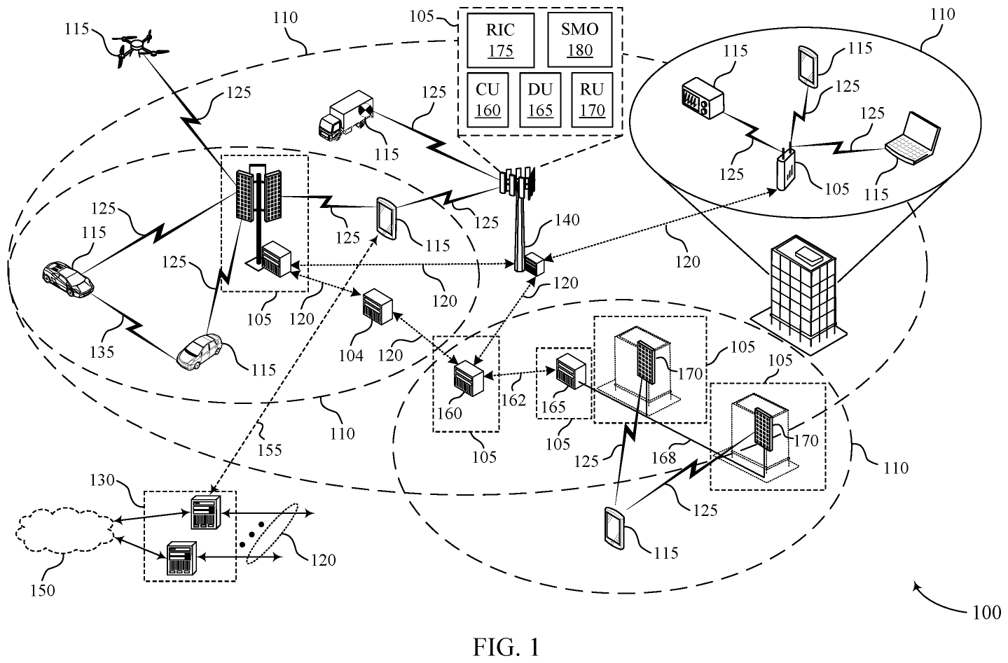

FIG. 1 shows an example of a wireless communications system 100 that supports band-specific power control with multi-band antenna modules in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support band-specific power control with multi-band antenna modules as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer a beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may receive a control message (e.g., from a network entity 105) indicating a power scaling parameter dedicated to a frequency subband of a band for wireless communications by an antenna panel at the UE 115. In some cases, the UE 115 may switch from a second frequency subband of the band to the frequency subband based on receiving the control message, and the UE 115 may switch from a second power scaling parameter associated with the second frequency subband to the power scaling parameter based on switching to the frequency subband. The UE 115 may transmit, by the antenna panel, a signal via the frequency subband at a transmit power that is based on the power scaling parameter dedicated to the frequency subband.

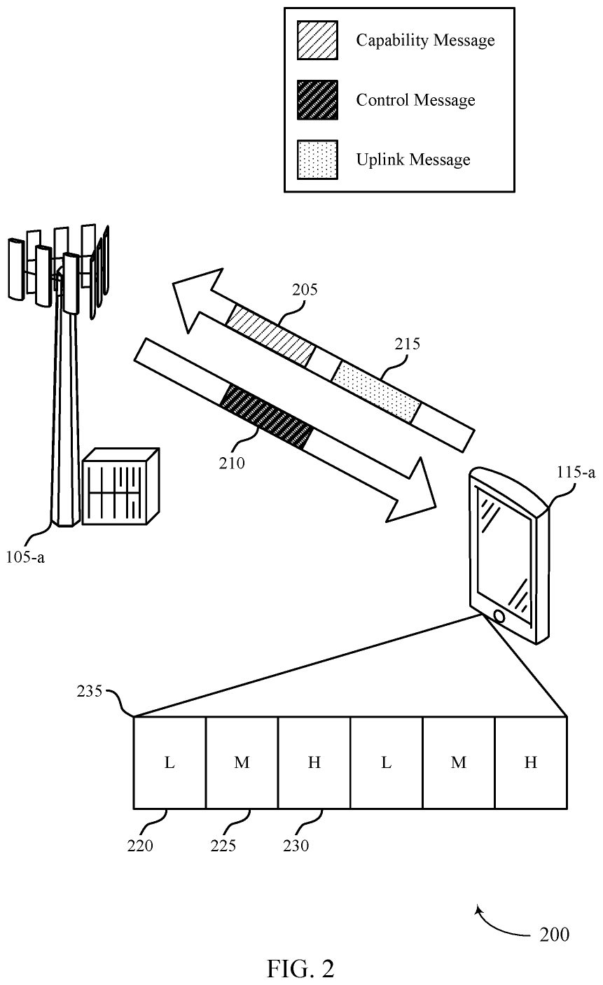

FIG. 2 shows an example of a wireless communications system 200 that supports band-specific power control with multi-band antenna modules in accordance with one or more aspects of the present disclosure. The wireless communications system 200 may implement or may be implemented by aspects of the wireless communications system 100. For example, the wireless communications system 200 may include a UE 115-a and a network entity 105-a, which may be examples of corresponding device as described with reference to FIG. 1.

The UE 115-a may transmit a capability message 205 to the network entity 105-a. The capability message 205 may indicate that the UE 115-a includes a multi-band antenna module 235. For example, the UE 115-a may transmit the capability message 205 indicating that an antenna panel (e.g., the multi-band antenna module 235) at the UE supports multiple frequency subbands of a band. In some examples, the multi-band antenna module 235 may include a low-band component 220, a mid-band component 225, and/or a high-band component 230, or any combination of two of the components. The low-band component 220 may support a first range of frequencies (e.g., 24.25-27 GHz), the mid-band component 225 may support a second range of frequencies greater than the first range of frequencies (e.g., 27-43.5 GHZ), and the high-band component 230 may support a third range of frequencies greater than both the first and the second range of frequencies (e.g., 47.2-48.2 GHZ).

In some cases, the multi-band antenna module 235 of the UE 115-a may support frequency subbands in different bands. For example, the multi-band antenna module 235 may support frequency subbands in a millimeter wave band or may be deployed in millimeter wave systems. Examples of millimeter wave bands may include frequency range 2 (FR2), frequency range 4 (FR4), and/or frequency range (5), or any combination of these ranges of a radio access technology. In some cases, frequency range 1 (FR1) of a radio access technology (e.g., 3GPP wireless technologies) may range between 410 MHz to 7125 MHz. FR2 of the radio access technology may range between 24.25 GHz to 71 GHz. FR3 of the radio access technology may range between 7125 MHz and 24.25 GHZ, FR4 of the radio access technology may range between 71 GHz and 114.25 GHz. FR5 of the radio access technology may range between 114.25 GHz to 300 GHz and beyond. In some examples, the multi-band antenna module 235 may support additional frequency subbands or frequency ranges outside of the millimeter wave band (such as FR3 or beyond FR5). For the multi-band antenna module 235, an inter-antenna element spacing may be the same as frequency coverage changes. For example, the inter-antenna element spacing may be the same for the low-band component 220, the mid-band component 225, and the high-band component 230.

The UE 115-a may use the multi-band antenna module 235 to transmit a signal, such as an uplink message 215. The UE 115-a may transmit the uplink message 215 via beamformed transmissions (e.g., using an uplink beam). In some examples, beam properties for the beam may change significantly as an operating frequency of the multi-band antenna module 235 changes. In some phased array antennas, it may be desirable to have antenna elements spaced 0.51 apart relative to the operating frequency of the phased array antenna. However, it may be impractical to change the distance between antenna elements in response to changing an operating frequency. It may also be impractical to have separate antenna modules for each different possible operating frequency. In such cases, a multi-band antenna module may be configured to communicate over a range of operating frequencies with a single fixed spacing between antenna elements. Channel properties (e.g., path loss, angular spreads) may also change with changes in operating frequency. Accordingly, the UE 115-a may change uplink power control operations (e.g., transmit power) for the uplink message 215 based on using the multi-band antenna module 235 to transmit the message. The changes in uplink power control operations may be band-specific and may be based on the operating frequency of the multi-band antenna module 235.

The UE 115-a may transmit the uplink message 215 in accordance with a power control model (e.g., power control loop). The uplink message 215 may include a physical uplink shared channel (PUSCH), a physical uplink control channel (PUCCH), a sounding reference signal (SRS), or a combination thereof. The power control model over the i-th subcarrier may be represented by Equation 1.

$${P}_{PUSCH} ( i ) = min \{ {P}_{CMAX} , 10 {log}_{10} ( {M}_{PUSCH} ( i ) ) + {P}_{{O}_{PUSCH}} ( j ) + α ( j ) \cdot PL + {Δ}_{T F} ( i ) + f ( i ) \} \qquad ( 1 )$$

In Equation 1, P_{PUSCH} is a power associated with the uplink message 215 and is given in dBm. PCMAX may correspond to a max UE power for the UE 115-a, 10 log₁₀(M_{PUSCH} (i)) may correspond to a number of RBs, P_{O}_{_{PUSCH}} (j) may correspond to a target base station receive (Rx) power for the network entity 105-a, a (j)·PL may correspond to a path loss, Δ_{TF}(i) may correspond to a transmission format (e.g., an MCS) for the uplink message 215, and f(i) may correspond to a closed loop power control value (e.g., a power scaling parameter).

Based on the power control model, the power (e.g., P_{PUSCH}) associated with the uplink message 215 may be based on the operating frequency of the multi-band antenna module 235. For example, the path loss may include a propagation loss and an array gain due to beamforming. The propagation loss may be a function of carrier frequency. Assuming line-of-sight (LOS) conditions, with a path loss exponent (PLE) of 2, the power needed for reliable 71 GHz transmissions may be 1.9 dB less than the power needed for a 57 GHz transmission (e.g., due to a higher propagation loss for the 71 GHz transmission). For a PLE of 3, the difference in power may be 2.9 dB. The array gain may also be a function of carrier frequency based on the multi-band antenna module 235 having a fixed inter-antenna element spacing. The parameter a in the power control model may be an optimization parameter between zero and one. α may be set low for high interference settings, or α may be set high to compensate for path loss.

In some examples, the network entity 105-a may indicate changes to uplink power control operations for the UE 115-a via the control message 210. The control message 210 may include feedback of band-specific power control parameters based on changes to beam properties (e.g., that the network entity 105-a may observe or determine). For example, the UE 115-a may receive the control message 210 indicating a power scaling parameter (e.g., f(i)) dedicated to a frequency subband (e.g., n257) of a band (e.g., millimeter wave band). The UE 115-a may transmit, by the multi-band antenna module 235, the uplink message 215 via the frequency subband at a transmit power, and the transmit power may be based on the power scaling parameter dedicated to the frequency subband.

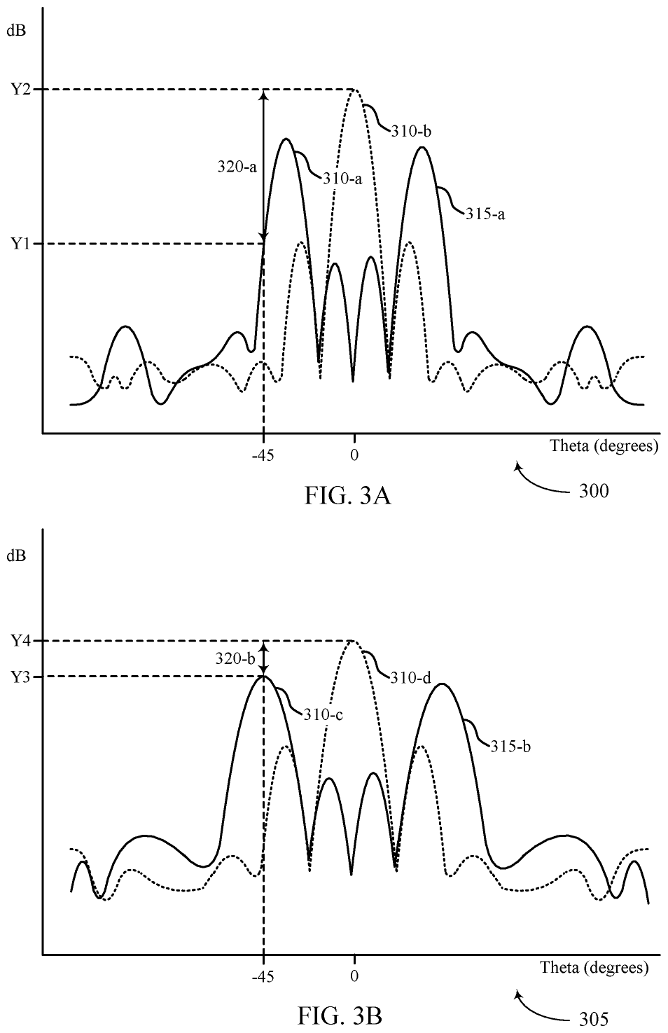

FIGS. 3A and 3B show examples of a beam property graph 300 and a beam property graph 305 that support band-specific power control with multi-band antenna modules in accordance with one or more aspects of the present disclosure. The beam property graph 300 and the beam property graph 305 may implement or may be implemented by aspects of the wireless communications system 100 or the wireless communications system 200. For example, the beam property graph 300 and the beam property graph 305 may illustrate beam properties of an uplink message 215 transmitted by a UE 115-a, as described with reference to FIG. 2.

In some examples, elemental gain may drift or droop with respect to the boresight direction of an antenna array (e.g., of a multi-band antenna module). A model for how much the elemental gain droops may be 10 log₁₀(cos(θ)^{1.5}) in dB, where θ is the angle off-boresight. For a ±45° beam scanning (e.g., 0=) 45°, the elemental gain droop may be 2.25 dB, and for a ±60° beam scanning (e.g., 0=) 60°, the elemental gain droop may be 4.5 dB. The model for elemental gain droop may assume that an inter-antenna element spacing, d, is proportional to an operating frequency. For example, in some designs, d may be approximately λ/2, where λ is the wavelength associated with the operating frequency. The relationship between frequency and wavelength is c=f*λ, where c is the speed of light, f is the frequency and λ is the wavelength. However, for a multi-band antenna module, the operating frequency may change, but the inter-antenna element spacing may be fixed because of the way the multi-band antenna module is constructed. That is, d may be the same over any operating frequency. However, the size of d as a function of A may change as the operating frequency changes because the distance d is physically fixed.

In some cases, as the ratio between the wavelength and the inter-antenna element spacing gets closer to one (1) (e.g.,

$$d > \frac{λ}{2}$$

), the antenna may become more directive. In such cases, a peak gain may increase, elemental gain droops at off-boresight directions may increase, and a radiated energy may remain the same as in the

$$d = \frac{λ}{2}$$

case. The changes to peak gain and elemental gain droops at off-boresight directions due to the inter-antenna element spacing being the same across operating frequencies (e.g., as opposed to

$$d = \frac{λ}{2}$$

) may impact uplink power control operations for a UE 115 with a multi-band antenna module.

The beam property graph 300 may illustrate the elemental gain in dB for an operating frequency of 43 GHz and an inter-antenna element spacing of around 5.6 mm, which results in an inter-antenna element spacing of 0.81λ as a function of wavelength. A main lobe 310-a may correspond to a beam for an antenna element pointed at a direction −45° from the boresight direction, and a main lobe 310-b may correspond to a beam for an antenna element pointed in the boresight direction (e.g., 0°). For an off-boresight angle of −45°, an elemental gain Y1 may be less than an elemental gain Y2 (e.g., a peak gain) by a delta 320-a (e.g., Δ₁). The delta 320-a may correspond to an elemental gain droop due to the antenna element being pointed at an angle (e.g., −45°) relative to the boresight direction.

In some examples, reducing inter-antenna element spacing may improve elemental gain for off-boresight beam scanning. The beam property graph 305 may illustrate the elemental gain in dB for an operating frequency of 36 GHz and an inter-antenna element spacing of around 5.6 mm, which results in an inter-antenna element spacing of 0.671 as a function of wavelength. A main lobe 310-c may correspond to a beam for an antenna element pointed at a direction −45° from the boresight direction, and a main lobe 310-d may correspond to a beam for an antenna element pointed in the boresight direction (e.g., 0°). For an off-boresight angle of −45°, an elemental gain Y3 for the main lobe 310-c may be less than an elemental gain Y4 (e.g., a peak gain) by a delta 320-b (e.g., Δ₂). The delta 320-b may correspond to an elemental gain droop due to the antenna element being pointed at an angle of −45° relative to the boresight direction.

However, the delta 320-b, corresponding to the inter-antenna element spacing of 0.671, may be less than the delta 320-a, corresponding to the inter-antenna element spacing of 0.811. That is, by reducing the inter-antenna element spacing, the elemental gain at +45° beam scanning may be increased by an amount equal to the difference of delta 320-a and delta 320-b (e.g., 41-42, 2.5 dB), and the elemental gain droop may be reduced. However, a multi-band antenna module may have a uniform inter-antenna element spacing across operating frequencies, and a UE 115 using a multi-band antenna module may be unable to reduce the elemental gain droop by reducing the inter-antenna element spacing.

As the UE 115 operates across different frequency bands, channel properties may change. For example, path loss, which may be approximately

$$PLE * 10 * {log}_{10} ( \frac{{f}_{1}}{{f}_{2}} ) ,$$

angular speed, gain of cluster, or other channel properties may change with a change in operating frequency. The UE 115 may implement band-specific power control techniques to mitigate impact due to channel properties changing across operating frequencies (e.g., due to changing relationships between antenna spacings and the wavelengths of operating frequencies). However, in addition to changes in channel properties, elemental gain droop may also change as the UE 115 operates across different frequency bands, and the elemental gain droop may impact an uplink power that the UE 115 can generate. For example, when the UE switches operations from 36 to 43 GHz, the element spacing may remain the same, but relative to the operating frequency 1, the element spacing ratio may change from 0.811, as illustrated by the beam property graph 300, to 0.671, as illustrated by the beam property graph 305. Thus, for a beam steered to 45° away (e.g., −45°) from the boresight direction, there may be an elemental gain droop equal to the difference between delta 320-a and delta 320-b (e.g., Δ₁−Δ₂, 2.5 dB).

In some cases, a link budget of the UE 115 may not be saturated. That is, the UE 115 may transmit a signal, and a power for the signal may not meet or may not exceed PCMAX of the power control model, described in greater detail with reference to FIG. 2, or a power amplifier of the UE 115 may operate below a saturation power (e.g., a threshold power), Pₛₐₜ. In such cases, the UE 115 may compensate for the elemental gain droop with a band-specific power control parameter change, which may increase the transmit power for the signal. For example, the UE 115 may transmit, by an antenna panel (e.g., of a multi-band antenna module), the signal via a frequency subband (e.g., an operating frequency) at a transmit power that is based on a power scaling parameter, and the power scaling parameter may be dedicated to the frequency subband. The power scaling parameter may differ from a power control parameter previously configured for the UE 115. The UE 115 may switch from a second power scaling parameter to the power scaling parameter based on switching from a second frequency subband to the frequency subband. For example, if the UE switches operations from 36 to 43 GHZ, the UE may switch from using a first power scaling factor associated with 320-b to using a second power scaling factor associated with 320-a.

In some examples, the UE 115 may transmit signals at high frequencies using the multi-band antenna module, and the transmitted signals may induce grating lobes, which may cause interference. For example, the transmitted signal illustrated by beam property graph 300 may include the main lobe 310-a and may also include a grating lobe 315-a. Similarly, the main lobe 310-c of the beam property graph 300 may correspond to a grating lobe 315-b. The UE 115 may limit a scan range (e.g., a threshold angle from the boresight direction) at some high frequencies to avoid grating lobes.

In some cases, a dominant cluster in a channel may be in a first direction that induces a grating lobe 315. In such cases, increasing the transmit power for signals in the first direction using band-specific power control parameter changes may cause interference in the first direction or in other directions, which may affect network performance, for example, at a network entity 105. Thus, the UE 115 may coordinate with the network entity 105 regarding the band-specific power control parameter change. For example, the UE 115 may receive a control message indicating the power scaling parameter dedicated to the frequency subband of a band (e.g., FR2) for wireless communications by the antenna panel at the UE 115. In some examples, the UE 115 may receive a second control message indicating an offset associated with the power scaling parameter.

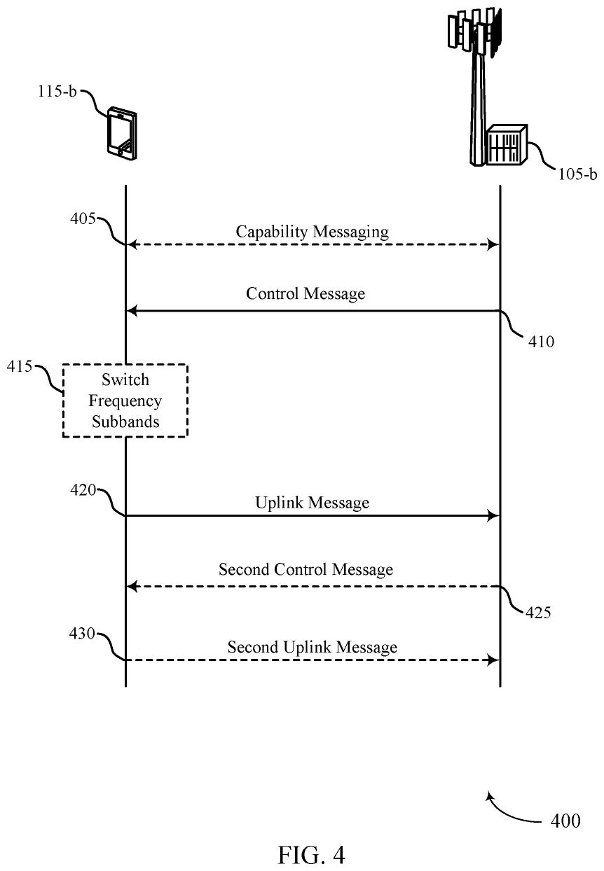

FIG. 4 shows an example of a process flow 400 that supports band-specific power control with multi-band antenna modules in accordance with one or more aspects of the present disclosure. The process flow 400 may implement or may be implemented by aspects of the wireless communications system 100 or the wireless communications system 200. For example, the process flow 400 may include a UE 115-b and a network entity 105-b, which may be examples of corresponding devices and entities as described with reference to FIGS. 1 and 2. In the following description of the process flow 400, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 400, and other operations may be added to the process flow 400.

At 405, the UE 115-b and the network entity 105-b may exchange capability messaging. For example, the UE 115-b may transmit a capability message indicating an antenna panel at the UE 115-b supports multiple frequency subbands of a band (e.g., FR2, FR3, FR4, and/or FR5). The capability message may indicate that the antenna panel at the UE 115-b is a multi-band antenna module or a component of a multi-band antenna module. In some examples, the network entity 105-b may transmit one or more capability messages or one or more responses to the capability messages transmitted by the UE 115-b.

At 410, the UE 115-b may receive a control message indicating a power scaling parameter (e.g., f(i)) dedicated to a frequency subband of the band for wireless communications by the antenna panel at the UE. For example, upon indication of a multi-band antenna module capability at the UE 115-b, the network entity 105-b and the UE 115-b may coordinate the use of band-specific power control parameters to accommodate channel and beamforming changes (e.g., path loss, angular spreads, gain of cluster, elemental gain droop) due to communicating using a multi-band antenna module at different operating frequencies. In some cases, the control message may indicate multiple power scaling parameters, each power scaling parameter of the multiple power scaling parameters dedicated to a respective frequency subband of the band. The control message may be an example of an uplink control information (UCI) message or a MAC-control element (MAC-CE) message.

At 415, the UE 115-b may switch (e.g., perform a band switch) from a second frequency subband to the frequency subband based on receiving the control message. The UE 115-b may switch from a second power scaling parameter associated with the second frequency subband to the power scaling parameter based on switching to the frequency subband. In some examples, the UE 115-b may transmit signals based on a closed loop power control value, f(i), and f(i) may be adjusted or updated with the band switch. For example, the frequency subband may be a higher frequency subband than the second frequency subband, and the power scaling parameter (e.g., f(i)) may indicate increasing the transmit power for transmitting the signal relative to the second power scaling parameter. That is, f(i) may be increased with an increase in operating frequency, or vice versa. At 420, the UE 115-b may transmit, by the antenna panel (e.g., the multi-band antenna module), a signal via the frequency subband at the transmit power that is based on the power scaling parameter dedicated to the frequency subband.

In some cases, additionally or alternatively with adjusting the power control parameters the UE 115-b may change one or more other parameters. For example, the UE 115-b may not change power control parameters as operating frequency changes (e.g., increases) or may not change power control parameters in response to performing a band switch. In such cases, or in other cases, a power budget (e.g., based on an MCS for a lower operating frequency) may fall short at a higher operating frequency. In such cases, the UE 115-b may indicate a lower MCS (e.g., lower order MCS) to be used at the higher frequency. In some examples, the UE 115-b may use the lower MCS at the higher frequency with the same power control parameters as the lower frequency, or the UE 115-b may use the lower MCS in addition to the band-specific power control parameter change for the higher frequency. For example, at 425, the UE 115-b may receive a second control message indicating an MCS dedicated to the frequency subband of the band for wireless communications by the antenna panel at the UE. At 430, the UE 115-b may transmit, by the antenna panel, a second signal via the frequency subband using the MCS dedicated to the frequency subband.

In some cases, as power control parameter (e.g., f(i)) is increased with an increase in operating frequency, the multi-band antenna module at the UE 115-b may induce grating lobes at some directions. The grating lobes may be mitigated via feedback of interference metrics from the network entity 105-b. Thus, the power control parameter, f(i), may be optimized relative to the band-specific power control parameter change. For example, at 425, the UE 115-b may receive the second control message indicating an offset associated with the power scaling parameter. In some cases, the second control message may indicate one or more interference measurements, and the UE 115-b may determine the offset. The second control message may include an indication of one or more grating lobes. The one or more grating lobes may be based on transmitting the signal via the frequency subband at the transmit power.

At 430, the UE 115-b may transmit the signal at a second transmit power based on the offset. In some cases, the UE 115-b may determine the second transmit power without indication from the network entity 105-b, or the network entity 105-b may indicate the second transmit power explicitly (e.g., via the second control message), or implicitly (e.g., based on the interference measurements, based on the indication of grating lobes).

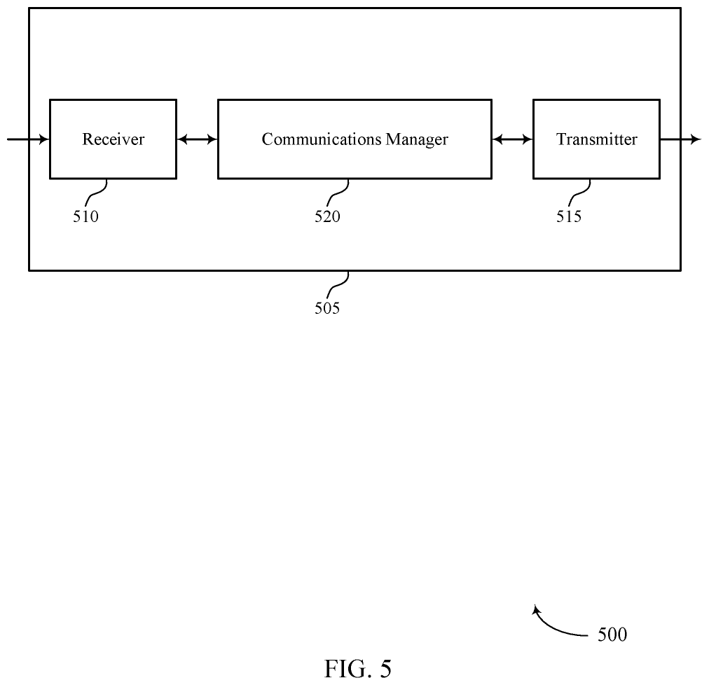

FIG. 5 shows a block diagram 500 of a device 505 that supports band-specific power control with multi-band antenna modules in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to band-specific power control with multi-band antenna modules). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to band-specific power control with multi-band antenna modules). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of band-specific power control with multi-band antenna modules as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 is capable of, configured to, or operable to support a means for transmitting a capability message indicating an antenna panel at the UE supports a set of multiple frequency subbands of a band. The communications manager 520 is capable of, configured to, or operable to support a means for receiving, based on transmitting the capability message, a control message indicating a power scaling parameter dedicated to a frequency subband of the band for wireless communications by the antenna panel at the UE. The communications manager 520 is capable of, configured to, or operable to support a means for transmitting, by the antenna panel, a signal via the frequency subband at a transmit power that is based on the power scaling parameter dedicated to the frequency subband.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing and reduced power consumption. For example, by utilizing band-specific power scaling parameters, the device 505 may reduce a need for retransmitting signals transmitted at an insufficient transmit power or transmitted with large interference by increasing the transmit power for such signals. Accordingly, the device 505 may support reducing a quantity of transmissions for transmitting a signal accurately, which may reduce processing and power consumption associated with transmitting the signals.

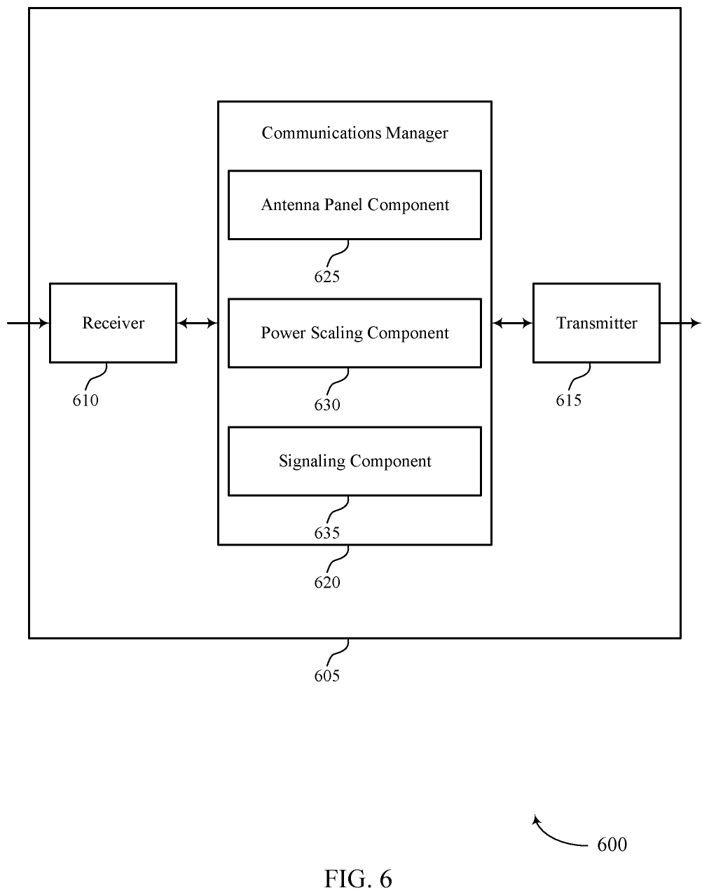

FIG. 6 shows a block diagram 600 of a device 605 that supports band-specific power control with multi-band antenna modules in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to band-specific power control with multi-band antenna modules). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to band-specific power control with multi-band antenna modules). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of band-specific power control with multi-band antenna modules as described herein. For example, the communications manager 620 may include an antenna panel component 625, a power scaling component 630, a signaling component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The antenna panel component 625 is capable of, configured to, or operable to support a means for transmitting a capability message indicating an antenna panel at the UE supports a set of multiple frequency subbands of a band. The power scaling component 630 is capable of, configured to, or operable to support a means for receiving, based on transmitting the capability message, a control message indicating a power scaling parameter dedicated to a frequency subband of the band for wireless communications by the antenna panel at the UE. The signaling component 635 is capable of, configured to, or operable to support a means for transmitting, by the antenna panel, a signal via the frequency subband at a transmit power that is based on the power scaling parameter dedicated to the frequency subband.

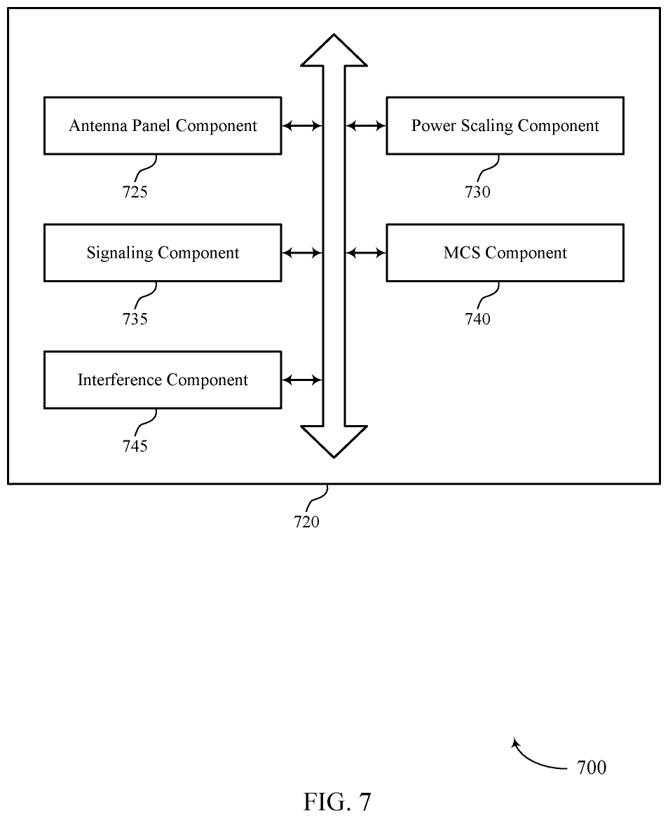

FIG. 7 shows a block diagram 700 of a communications manager 720 that supports band-specific power control with multi-band antenna modules in accordance with one or more aspects of the present disclosure. The communications manager 720 may be an example of aspects of a communications manager 520, a communications manager 620, or both, as described herein. The communications manager 720, or various components thereof, may be an example of means for performing various aspects of band-specific power control with multi-band antenna modules as described herein. For example, the communications manager 720 may include an antenna panel component 725, a power scaling component 730, a signaling component 735, an MCS component 740, an interference component 745, or any combination thereof. Each of these components, or components or subcomponents thereof (e.g., one or more processors, one or more memories), may communicate, directly or indirectly, with one another (e.g., via one or more buses).

The communications manager 720 may support wireless communication at a UE in accordance with examples as disclosed herein. The antenna panel component 725 is capable of, configured to, or operable to support a means for transmitting a capability message indicating an antenna panel at the UE supports a set of multiple frequency subbands of a band. The power scaling component 730 is capable of, configured to, or operable to support a means for receiving, based on transmitting the capability message, a control message indicating a power scaling parameter dedicated to a frequency subband of the band for wireless communications by the antenna panel at the UE. The signaling component 735 is capable of, configured to, or operable to support a means for transmitting, by the antenna panel, a signal via the frequency subband at a transmit power that is based on the power scaling parameter dedicated to the frequency subband.

In some examples, the antenna panel component 725 is capable of, configured to, or operable to support a means for switching from a second frequency subband of the band to the frequency subband based on receiving the control message. In some examples, the power scaling component 730 is capable of, configured to, or operable to support a means for switching from a second power scaling parameter associated with the second frequency subband to the power scaling parameter based on switching to the frequency subband.

In some examples, the frequency subband is a higher frequency than the second frequency subband, and the power scaling parameter indicates increasing the transmit power for transmitting the signal relative to the second power scaling parameter.

In some examples, the frequency subband is a lower frequency than the second frequency subband, and the power scaling parameter indicates decreasing the transmit power for transmitting the signal relative to the second power scaling parameter.

In some examples, the control message indicates a set of multiple power scaling parameters, each power scaling parameter of the set of multiple power scaling parameters dedicated to a respective frequency subband of the band.

In some examples, the MCS component 740 is capable of, configured to, or operable to support a means for receiving a second control message indicating an MCS dedicated to the frequency subband of the band for wireless communications by the antenna panel at the UE. In some examples, the signaling component 735 is capable of, configured to, or operable to support a means for transmitting, by the antenna panel, a second signal via the frequency subband using the MCS dedicated to the frequency subband.

In some examples, the power scaling component 730 is capable of, configured to, or operable to support a means for receiving a second control message indicating an offset associated with the power scaling parameter, where transmitting the signal further includes transmitting the signal at a second transmit power based on the offset.

In some examples, the second transmit power is less than the transmit power.

In some examples, the interference component 745 is capable of, configured to, or operable to support a means for receiving a second control message indicating one or more interference measurements based on receiving the control message. In some examples, the power scaling component 730 is capable of, configured to, or operable to support a means for determining an offset associated with the power scaling parameter based on receiving the second control message, where transmitting the signal further includes transmitting the signal at a second transmit power based on the offset.

In some examples, the second control message includes an indication of one or more grating lobes, the one or more grating lobes based on transmitting the signal via the frequency subband at the transmit power.

In some examples, the control message includes a UCI message or a MAC-CE message.

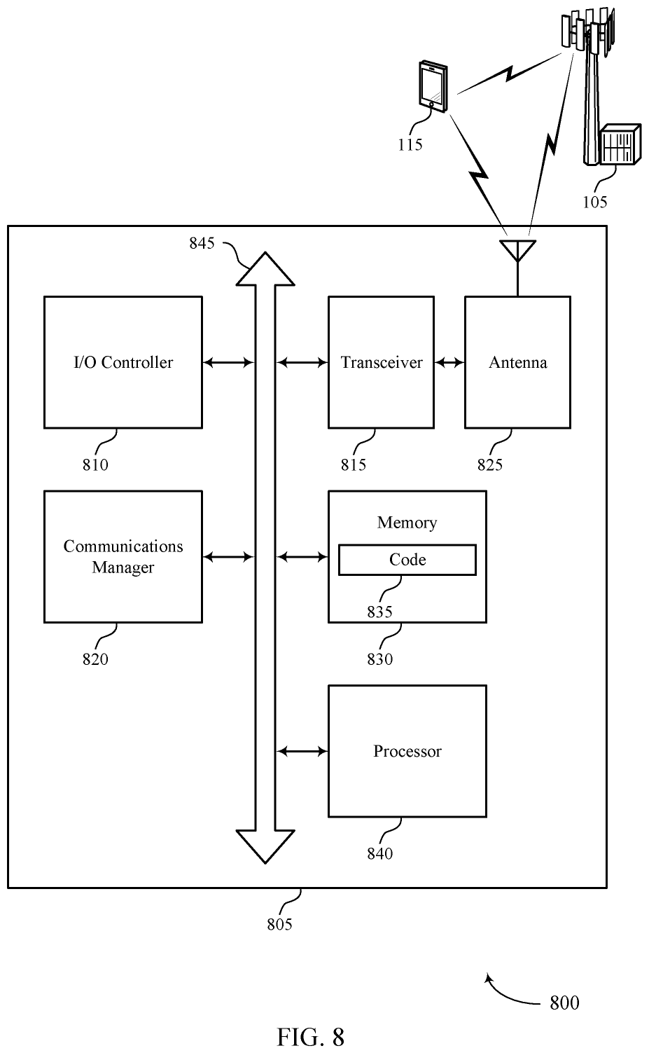

FIG. 8 shows a diagram of a system 800 including a device 805 that supports band-specific power control with multi-band antenna modules in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting band-specific power control with multi-band antenna modules). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein.

The communications manager 820 may support wireless communication at a UE in accordance with examples as disclosed herein. For example, the communications manager 820 is capable of, configured to, or operable to support a means for transmitting a capability message indicating an antenna panel at the UE supports a set of multiple frequency subbands of a band. The communications manager 820 is capable of, configured to, or operable to support a means for receiving, based on transmitting the capability message, a control message indicating a power scaling parameter dedicated to a frequency subband of the band for wireless communications by the antenna panel at the UE. The communications manager 820 is capable of, configured to, or operable to support a means for transmitting, by the antenna panel, a signal via the frequency subband at a transmit power that is based on the power scaling parameter dedicated to the frequency subband.

By including or configuring the communications manager 820 in accordance with examples as described herein, the device 805 may support techniques for improved communication reliability and improved coordination between devices. For example, by using band-specific power scaling parameters, the device 805 may support increased coordination between devices by communicating information about a power for transmitting or receiving signals. The device 805 may support improved communication reliability because signals transmitted in accordance with a band-specific power scaling parameter may be less likely to cause interference or be received in error.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of band-specific power control with multi-band antenna modules as described herein, or the at least one processor 840 and the at least one memory 830 may be otherwise configured to, individually or collectively, perform or support such operations.

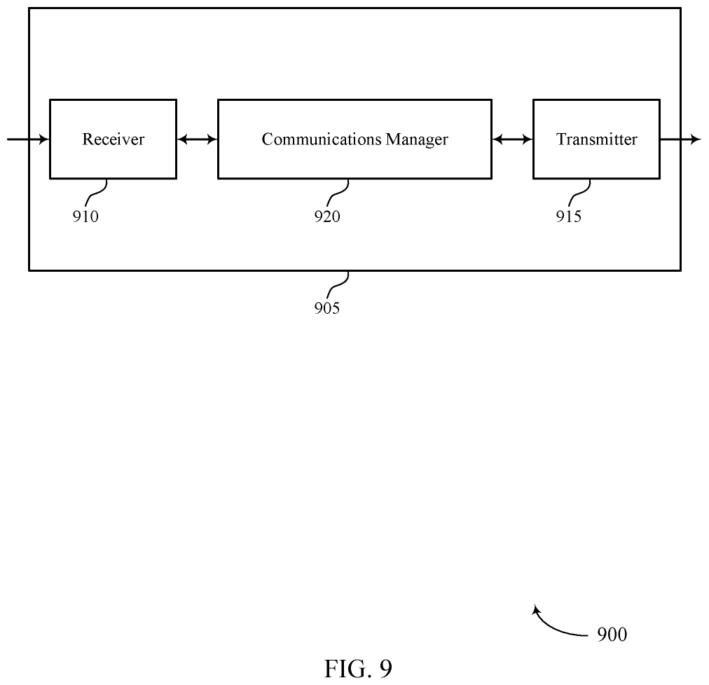

FIG. 9 shows a block diagram 900 of a device 905 that supports band-specific power control with multi-band antenna modules in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of band-specific power control with multi-band antenna modules as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 is capable of, configured to, or operable to support a means for receiving a capability message indicating an antenna panel at a UE supports a set of multiple frequency subbands of a band. The communications manager 920 is capable of, configured to, or operable to support a means for transmitting, based on receiving the capability message, a control message indicating a power scaling parameter dedicated to a frequency subband of the band for wireless communications by the antenna panel at the UE. The communications manager 920 is capable of, configured to, or operable to support a means for receiving, from the antenna panel, a signal via the frequency subband at a transmit power that is based on the power scaling parameter dedicated to the frequency subband.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing and reduced power consumption. For example, by utilizing band-specific power scaling parameters, the device 905 may reduce a need for retransmitting signals transmitted at an insufficient transmit power or transmitted with large interference by increasing the transmit power for such signals. Accordingly, the device 905 may support reducing a quantity of transmissions for transmitting a signal accurately, which may reduce processing and power consumption associated with transmitting the signals.

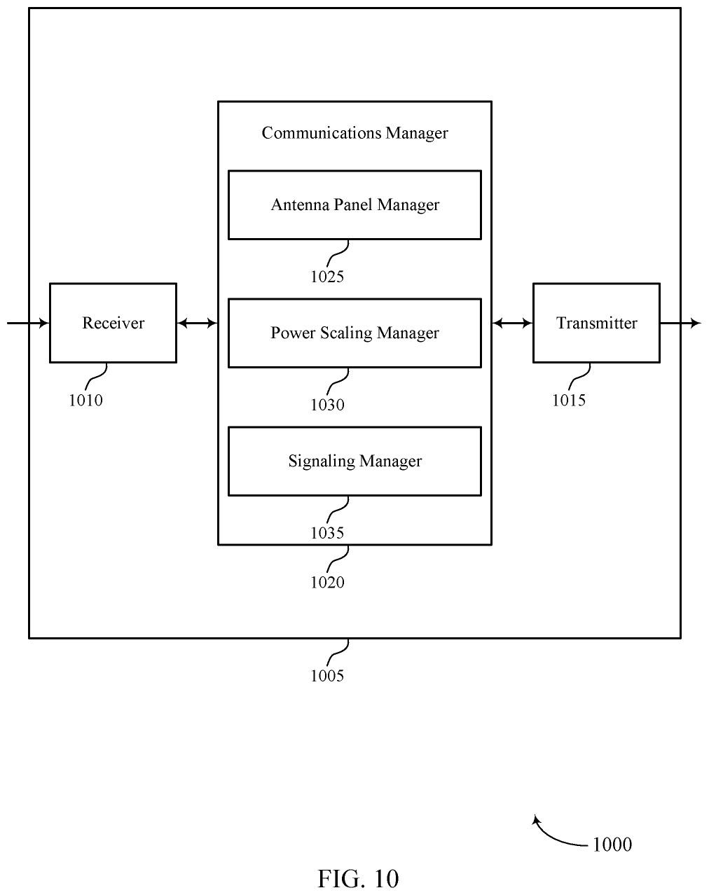

FIG. 10 shows a block diagram 1000 of a device 1005 that supports band-specific power control with multi-band antenna modules in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of band-specific power control with multi-band antenna modules as described herein. For example, the communications manager 1020 may include an antenna panel manager 1025, a power scaling manager 1030, a signaling manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The antenna panel manager 1025 is capable of, configured to, or operable to support a means for receiving a capability message indicating an antenna panel at a UE supports a set of multiple frequency subbands of a band. The power scaling manager 1030 is capable of, configured to, or operable to support a means for transmitting, based on receiving the capability message, a control message indicating a power scaling parameter dedicated to a frequency subband of the band for wireless communications by the antenna panel at the UE. The signaling manager 1035 is capable of, configured to, or operable to support a means for receiving, from the antenna panel, a signal via the frequency subband at a transmit power that is based on the power scaling parameter dedicated to the frequency subband.

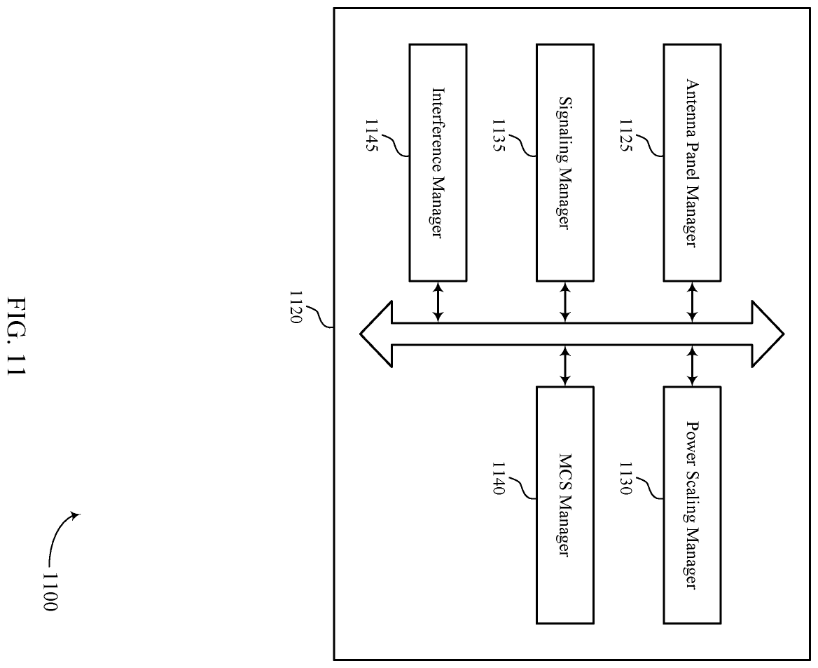

FIG. 11 shows a block diagram 1100 of a communications manager 1120 that supports band-specific power control with multi-band antenna modules in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of band-specific power control with multi-band antenna modules as described herein. For example, the communications manager 1120 may include an antenna panel manager 1125, a power scaling manager 1130, a signaling manager 1135, an MCS manager 1140, an interference manager 1145, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The antenna panel manager 1125 is capable of, configured to, or operable to support a means for receiving a capability message indicating an antenna panel at a UE supports a set of multiple frequency subbands of a band. The power scaling manager 1130 is capable of, configured to, or operable to support a means for transmitting, based on receiving the capability message, a control message indicating a power scaling parameter dedicated to a frequency subband of the band for wireless communications by the antenna panel at the UE. The signaling manager 1135 is capable of, configured to, or operable to support a means for receiving, from the antenna panel, a signal via the frequency subband at a transmit power that is based on the power scaling parameter dedicated to the frequency subband.

In some examples, the control message includes an indication to switch from a second frequency subband of the band to the frequency subband and to switch from a second power scaling parameter associated with the second frequency subband to the power scaling parameter.

In some examples, the frequency subband is a higher frequency than the second frequency subband, and the power scaling parameter indicates increasing the transmit power for transmitting the signal relative to the second power scaling parameter.

In some examples, the frequency subband is a lower frequency than the second frequency subband, and the power scaling parameter indicates decreasing the transmit power for transmitting the signal relative to the second power scaling parameter.

In some examples, the control message indicates a set of multiple power scaling parameters, each power scaling parameter of the set of multiple power scaling parameters dedicated to a respective frequency subband of the band.

In some examples, the MCS manager 1140 is capable of, configured to, or operable to support a means for transmitting a second control message indicating an MCS dedicated to the frequency subband of the band for wireless communications by the antenna panel at the UE. In some examples, the signaling manager 1135 is capable of, configured to, or operable to support a means for receiving, by the antenna panel, a second signal via the frequency subband based on the MCS dedicated to the frequency subband.

In some examples, the power scaling manager 1130 is capable of, configured to, or operable to support a means for transmitting a second control message indicating an offset associated with the power scaling parameter, where receiving the signal further includes receiving the signal at a second transmit power based on the offset.

In some examples, the second transmit power is less than the transmit power.

In some examples, the interference manager 1145 is capable of, configured to, or operable to support a means for transmitting a second control message indicating one or more interference measurements based on transmitting the control message, where receiving the signal further includes receiving the signal at a second transmit power based on the one or more interference measurements.

In some examples, the second control message includes an indication of one or more grating lobes, the one or more grating lobes based on receiving the signal via the frequency subband at the transmit power.

In some examples, the control message includes a UCI message or a MAC-CE message.

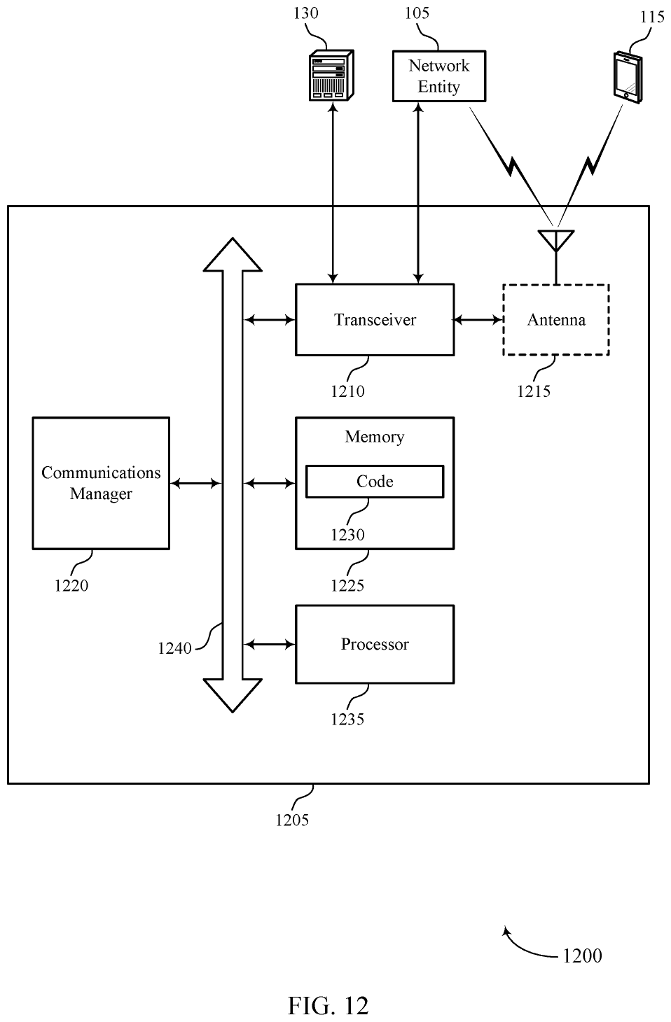

FIG. 12 shows a diagram of a system 1200 including a device 1205 that supports band-specific power control with multi-band antenna modules in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting band-specific power control with multi-band antenna modules). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some implementations, the at least one processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the at least one processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 is capable of, configured to, or operable to support a means for receiving a capability message indicating an antenna panel at a UE supports a set of multiple frequency subbands of a band. The communications manager 1220 is capable of, configured to, or operable to support a means for transmitting, based on receiving the capability message, a control message indicating a power scaling parameter dedicated to a frequency subband of the band for wireless communications by the antenna panel at the UE. The communications manager 1220 is capable of, configured to, or operable to support a means for receiving, from the antenna panel, a signal via the frequency subband at a transmit power that is based on the power scaling parameter dedicated to the frequency subband.

By including or configuring the communications manager 1220 in accordance with examples as described herein, the device 1205 may support techniques for improved communication reliability and improved coordination between devices. For example, by using band-specific power scaling parameters, the device 1205 may support increased coordination between devices by communicating information about a power for transmitting or receiving signals. The device 1205 may support improved communication reliability because signals transmitted in accordance with a band-specific power scaling parameter may be less likely to cause interference or be received in error.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of band-specific power control with multi-band antenna modules as described herein, or the at least one processor 1235 and the at least one memory 1225 may be otherwise configured to, individually or collectively, perform or support such operations.

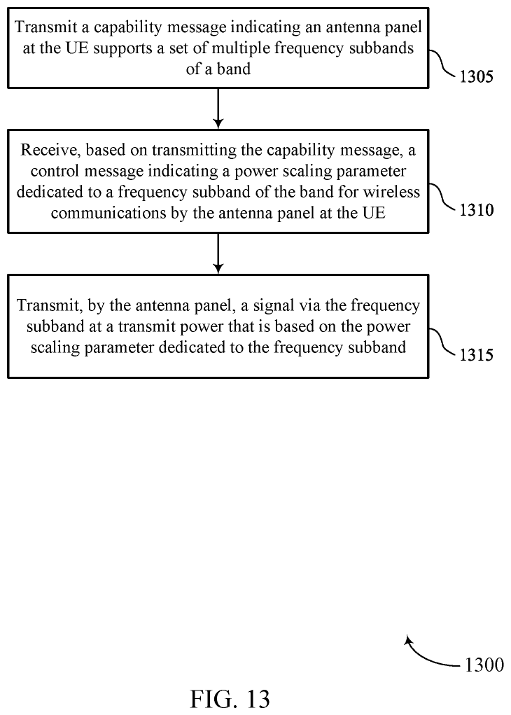

FIG. 13 shows a flowchart illustrating a method 1300 that supports band-specific power control with multi-band antenna modules in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a capability message indicating an antenna panel at the UE supports a set of multiple frequency subbands of a band. The operations of block 1305 may be performed in accordance with examples as disclosed herein. In some examples, aspects of the operations of 1305 may be performed by an antenna panel component 725 as described with reference to FIG. 7.

At 1310, the method may include receiving, based on transmitting the capability message, a control message indicating a power scaling parameter dedicated to a frequency subband of the band for wireless communications by the antenna panel at the UE. The operations of block 1310 may be performed in accordance with examples as disclosed herein. In some examples, aspects of the operations of 1310 may be performed by a power scaling component 730 as described with reference to FIG. 7.

At 1315, the method may include transmitting, by the antenna panel, a signal via the frequency subband at a transmit power that is based on the power scaling parameter dedicated to the frequency subband. The operations of block 1315 may be performed in accordance with examples as disclosed herein. In some examples, aspects of the operations of 1315 may be performed by a signaling component 735 as described with reference to FIG. 7.

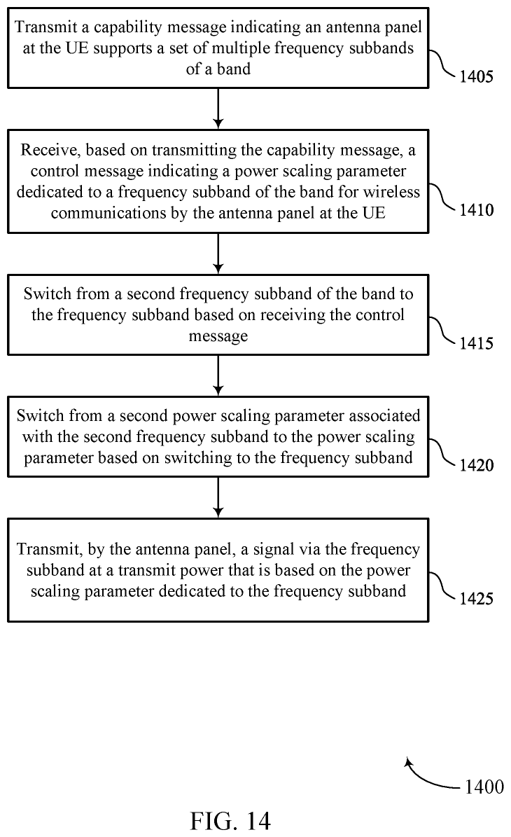

FIG. 14 shows a flowchart illustrating a method 1400 that supports band-specific power control with multi-band antenna modules in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a capability message indicating an antenna panel at the UE supports a set of multiple frequency subbands of a band. The operations of block 1405 may be performed in accordance with examples as disclosed herein. In some examples, aspects of the operations of 1405 may be performed by an antenna panel component 725 as described with reference to FIG. 7.

At 1410, the method may include receiving, based on transmitting the capability message, a control message indicating a power scaling parameter dedicated to a frequency subband of the band for wireless communications by the antenna panel at the UE. The operations of block 1410 may be performed in accordance with examples as disclosed herein. In some examples, aspects of the operations of 1410 may be performed by a power scaling component 730 as described with reference to FIG. 7.

At 1415, the method may include switching from a second frequency subband of the band to the frequency subband based on receiving the control message. The operations of block 1415 may be performed in accordance with examples as disclosed herein. In some examples, aspects of the operations of 1415 may be performed by an antenna panel component 725 as described with reference to FIG. 7.

At 1420, the method may include switching from a second power scaling parameter associated with the second frequency subband to the power scaling parameter based on switching to the frequency subband. The operations of block 1420 may be performed in accordance with examples as disclosed herein. In some examples, aspects of the operations of 1420 may be performed by a power scaling component 730 as described with reference to FIG. 7.

At 1425, the method may include transmitting, by the antenna panel, a signal via the frequency subband at a transmit power that is based on the power scaling parameter dedicated to the frequency subband. The operations of block 1425 may be performed in accordance with examples as disclosed herein. In some examples, aspects of the operations of 1425 may be performed by a signaling component 735 as described with reference to FIG. 7.

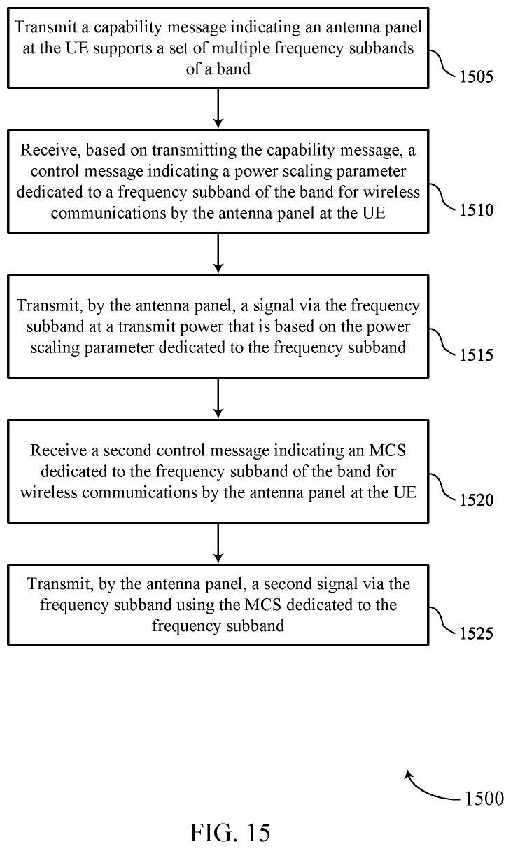

FIG. 15 shows a flowchart illustrating a method 1500 that supports band-specific power control with multi-band antenna modules in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting a capability message indicating an antenna panel at the UE supports a set of multiple frequency subbands of a band. The operations of block 1505 may be performed in accordance with examples as disclosed herein. In some examples, aspects of the operations of 1505 may be performed by an antenna panel component 725 as described with reference to FIG. 7.

At 1510, the method may include receiving, based on transmitting the capability message, a control message indicating a power scaling parameter dedicated to a frequency subband of the band for wireless communications by the antenna panel at the UE. The operations of block 1510 may be performed in accordance with examples as disclosed herein. In some examples, aspects of the operations of 1510 may be performed by a power scaling component 730 as described with reference to FIG. 7.

At 1515, the method may include transmitting, by the antenna panel, a signal via the frequency subband at a transmit power that is based on the power scaling parameter dedicated to the frequency subband. The operations of block 1515 may be performed in accordance with examples as disclosed herein. In some examples, aspects of the operations of 1515 may be performed by a signaling component 735 as described with reference to FIG. 7.

At 1520, the method may include receiving a second control message indicating an MCS dedicated to the frequency subband of the band for wireless communications by the antenna panel at the UE. The operations of block 1520 may be performed in accordance with examples as disclosed herein. In some examples, aspects of the operations of 1520 may be performed by an MCS component 740 as described with reference to FIG. 7.

At 1525, the method may include transmitting, by the antenna panel, a second signal via the frequency subband using the MCS dedicated to the frequency subband. The operations of block 1525 may be performed in accordance with examples as disclosed herein. In some examples, aspects of the operations of 1525 may be performed by a signaling component 735 as described with reference to FIG. 7.

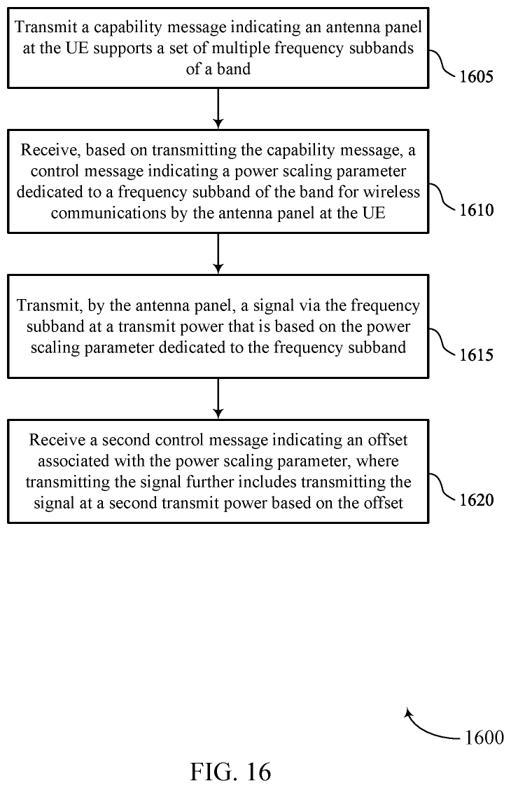

FIG. 16 shows a flowchart illustrating a method 1600 that supports band-specific power control with multi-band antenna modules in accordance with aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1605, the method may include transmitting a capability message indicating an antenna panel at the UE supports a set of multiple frequency subbands of a band. The operations of block 1605 may be performed in accordance with examples as disclosed herein. In some examples, aspects of the operations of 1605 may be performed by an antenna panel component 725 as described with reference to FIG. 7.

At 1610, the method may include receiving, based on transmitting the capability message, a control message indicating a power scaling parameter dedicated to a frequency subband of the band for wireless communications by the antenna panel at the UE. The operations of block 1610 may be performed in accordance with examples as disclosed herein. In some examples, aspects of the operations of 1610 may be performed by a power scaling component 730 as described with reference to FIG. 7.

At 1615, the method may include transmitting, by the antenna panel, a signal via the frequency subband at a transmit power that is based on the power scaling parameter dedicated to the frequency subband. The operations of block 1615 may be performed in accordance with examples as disclosed herein. In some examples, aspects of the operations of 1615 may be performed by a signaling component 735 as described with reference to FIG. 7.

At 1620, the method may include receiving a second control message indicating an offset associated with the power scaling parameter, where transmitting the signal further includes transmitting the signal at a second transmit power based on the offset. The operations of block 1620 may be performed in accordance with examples as disclosed herein. In some examples, aspects of the operations of 1620 may be performed by a power scaling component 730 as described with reference to FIG. 7.

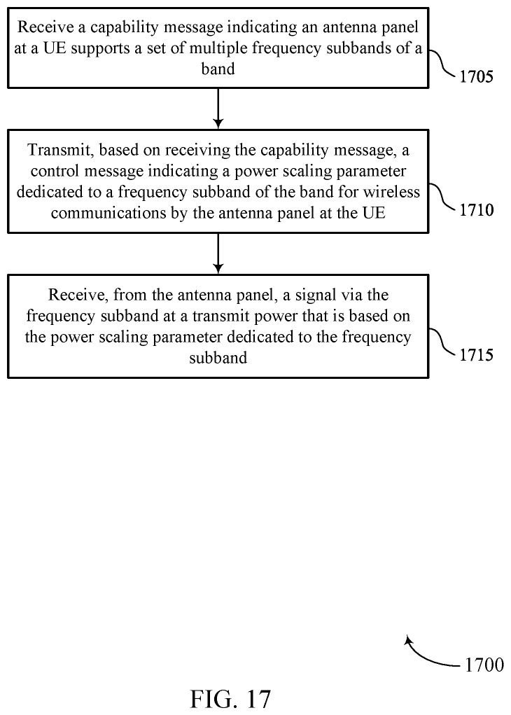

FIG. 17 shows a flowchart illustrating a method 1700 that supports band-specific power control with multi-band antenna modules in accordance with aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include receiving a capability message indicating an antenna panel at a UE supports a set of multiple frequency subbands of a band. The operations of block 1705 may be performed in accordance with examples as disclosed herein. In some examples, aspects of the operations of 1705 may be performed by an antenna panel manager 1125 as described with reference to FIG. 11.

At 1710, the method may include transmitting, based on receiving the capability message, a control message indicating a power scaling parameter dedicated to a frequency subband of the band for wireless communications by the antenna panel at the UE. The operations of block 1710 may be performed in accordance with examples as disclosed herein. In some examples, aspects of the operations of 1710 may be performed by a power scaling manager 1130 as described with reference to FIG. 11.

At 1715, the method may include receiving, from the antenna panel, a signal via the frequency subband at a transmit power that is based on the power scaling parameter dedicated to the frequency subband. The operations of block 1715 may be performed in accordance with examples as disclosed herein. In some examples, aspects of the operations of 1715 may be performed by a signaling manager 1135 as described with reference to FIG. 11.

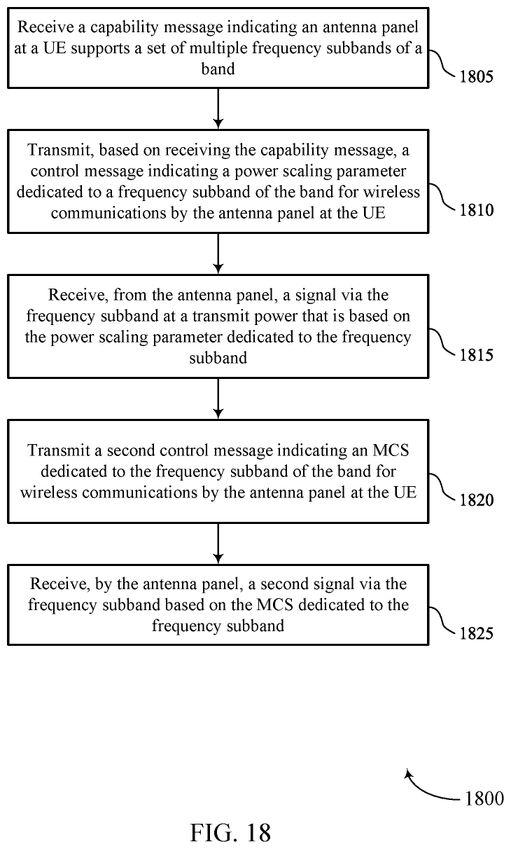

FIG. 18 shows a flowchart illustrating a method 1800 that supports band-specific power control with multi-band antenna modules in accordance with aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include receiving a capability message indicating an antenna panel at a UE supports a set of multiple frequency subbands of a band. The operations of block 1805 may be performed in accordance with examples as disclosed herein. In some examples, aspects of the operations of 1805 may be performed by an antenna panel manager 1125 as described with reference to FIG. 11.

At 1810, the method may include transmitting, based on receiving the capability message, a control message indicating a power scaling parameter dedicated to a frequency subband of the band for wireless communications by the antenna panel at the UE. The operations of block 1810 may be performed in accordance with examples as disclosed herein. In some examples, aspects of the operations of 1810 may be performed by a power scaling manager 1130 as described with reference to FIG. 11.

At 1815, the method may include receiving, from the antenna panel, a signal via the frequency subband at a transmit power that is based on the power scaling parameter dedicated to the frequency subband. The operations of block 1815 may be performed in accordance with examples as disclosed herein. In some examples, aspects of the operations of 1815 may be performed by a signaling manager 1135 as described with reference to FIG. 11.

At 1820, the method may include transmitting a second control message indicating an MCS dedicated to the frequency subband of the band for wireless communications by the antenna panel at the UE. The operations of block 1820 may be performed in accordance with examples as disclosed herein. In some examples, aspects of the operations of 1820 may be performed by an MCS manager 1140 as described with reference to FIG. 11.

At 1825, the method may include receiving, by the antenna panel, a second signal via the frequency subband based on the MCS dedicated to the frequency subband. The operations of block 1825 may be performed in accordance with examples as disclosed herein. In some examples, aspects of the operations of 1825 may be performed by a signaling manager 1135 as described with reference to FIG. 11.

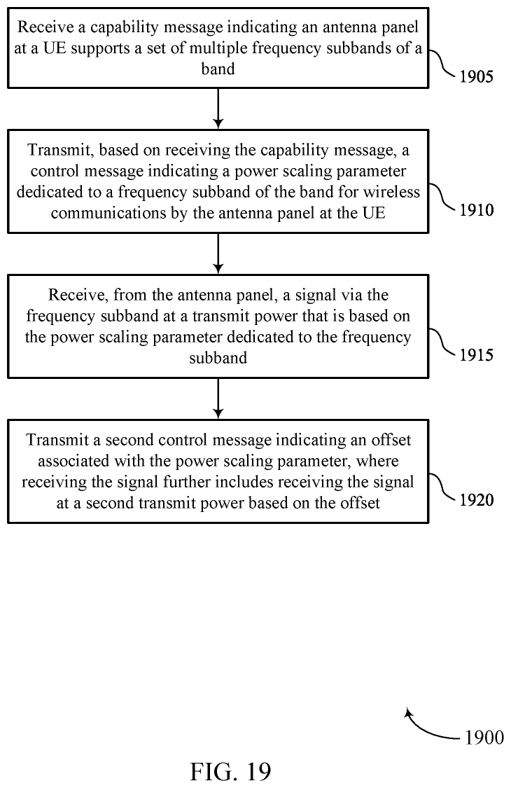

FIG. 19 shows a flowchart illustrating a method 1900 that supports band-specific power control with multi-band antenna modules in accordance with aspects of the present disclosure. The operations of the method 1900 may be implemented by a network entity or its components as described herein. For example, the operations of the method 1900 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1905, the method may include receiving a capability message indicating an antenna panel at a UE supports a set of multiple frequency subbands of a band. The operations of block 1905 may be performed in accordance with examples as disclosed herein. In some examples, aspects of the operations of 1905 may be performed by an antenna panel manager 1125 as described with reference to FIG. 11.

At 1910, the method may include transmitting, based on receiving the capability message, a control message indicating a power scaling parameter dedicated to a frequency subband of the band for wireless communications by the antenna panel at the UE. The operations of block 1910 may be performed in accordance with examples as disclosed herein. In some examples, aspects of the operations of 1910 may be performed by a power scaling manager 1130 as described with reference to FIG. 11.

At 1915, the method may include receiving, from the antenna panel, a signal via the frequency subband at a transmit power that is based on the power scaling parameter dedicated to the frequency subband. The operations of block 1915 may be performed in accordance with examples as disclosed herein. In some examples, aspects of the operations of 1915 may be performed by a signaling manager 1135 as described with reference to FIG. 11.

At 1920, the method may include transmitting a second control message indicating an offset associated with the power scaling parameter, where receiving the signal further includes receiving the signal at a second transmit power based on the offset. The operations of block 1920 may be performed in accordance with examples as disclosed herein. In some examples, aspects of the operations of 1920 may be performed by a power scaling manager 1130 as described with reference to FIG. 11.

The following provides an overview of aspects of the present disclosure:

Aspect 1: A method for wireless communication at a UE, comprising: transmitting a capability message indicating an antenna panel at the UE supports a plurality of frequency subbands of a band; receiving, based at least in part on transmitting the capability message, a control message indicating a power scaling parameter dedicated to a frequency subband of the band for wireless communications by the antenna panel at the UE; and transmitting, by the antenna panel, a signal via the frequency subband at a transmit power that is based at least in part on the power scaling parameter dedicated to the frequency subband.

Aspect 2: The method of aspect 1, further comprising: switching from a second frequency subband of the band to the frequency subband based at least in part on receiving the control message; and switching from a second power scaling parameter associated with the second frequency subband to the power scaling parameter based at least in part on switching to the frequency subband.

Aspect 3: The method of aspect 2, wherein the frequency subband is a higher frequency than the second frequency subband, and the power scaling parameter indicates increasing the transmit power for transmitting the signal relative to the second power scaling parameter.

Aspect 4: The method of any of aspects 2 through 3, wherein the frequency subband is a lower frequency than the second frequency subband, and the power scaling parameter indicates decreasing the transmit power for transmitting the signal relative to the second power scaling parameter.

Aspect 5: The method of any of aspects 1 through 4, wherein the control message indicates a plurality of power scaling parameters, each power scaling parameter of the plurality of power scaling parameters dedicated to a respective frequency subband of the band.

Aspect 6: The method of any of aspects 1 through 5, further comprising: receiving a second control message indicating an MCS dedicated to the frequency subband of the band for wireless communications by the antenna panel at the UE; and transmitting, by the antenna panel, a second signal via the frequency subband using the MCS dedicated to the frequency subband.

Aspect 7: The method of any of aspects 1 through 6, further comprising: receiving a second control message indicating an offset associated with the power scaling parameter, wherein transmitting the signal further comprises transmitting the signal at a second transmit power based at least in part on the offset.

Aspect 8: The method of aspect 7, wherein the second transmit power is less than the transmit power.

Aspect 9: The method of any of aspects 1 through 8, further comprising: receiving a second control message indicating one or more interference measurements based at least in part on receiving the control message; and determining an offset associated with the power scaling parameter based at least in part on receiving the second control message, wherein transmitting the signal further comprises transmitting the signal at a second transmit power based at least in part on the offset.

Aspect 10: The method of aspect 9, wherein the second control message includes an indication of one or more grating lobes, the one or more grating lobes based at least in part on transmitting the signal via the frequency subband at the transmit power.

Aspect 11: The method of any of aspects 1 through 10, wherein the control message comprises a UCI message or a MAC-CE message.

Aspect 12: A method for wireless communication at a network entity, comprising: receiving a capability message indicating an antenna panel at a UE supports a plurality of frequency subbands of a band; transmitting, based at least in part on receiving the capability message, a control message indicating a power scaling parameter dedicated to a frequency subband of the band for wireless communications by the antenna panel at the UE; and receiving, from the antenna panel, a signal via the frequency subband at a transmit power that is based at least in part on the power scaling parameter dedicated to the frequency subband.

Aspect 13: The method of aspect 12, wherein the control message includes an indication to switch from a second frequency subband of the band to the frequency subband and to switch from a second power scaling parameter associated with the second frequency subband to the power scaling parameter.

Aspect 14: The method of aspect 13, wherein the frequency subband is a higher frequency than the second frequency subband, and the power scaling parameter indicates increasing the transmit power for transmitting the signal relative to the second power scaling parameter.

Aspect 15: The method of any of aspects 13 through 14, wherein the frequency subband is a lower frequency than the second frequency subband, and the power scaling parameter indicates decreasing the transmit power for transmitting the signal relative to the second power scaling parameter.

Aspect 16: The method of any of aspects 12 through 15, wherein the control message indicates a plurality of power scaling parameters, each power scaling parameter of the plurality of power scaling parameters dedicated to a respective frequency subband of the band.

Aspect 17: The method of any of aspects 12 through 16, further comprising: transmitting a second control message indicating an MCS dedicated to the frequency subband of the band for wireless communications by the antenna panel at the UE; and receiving, by the antenna panel, a second signal via the frequency subband based at least in part on the MCS dedicated to the frequency subband.

Aspect 18: The method of any of aspects 12 through 17, further comprising: transmitting a second control message indicating an offset associated with the power scaling parameter, wherein receiving the signal further comprises receiving the signal at a second transmit power based at least in part on the offset.

Aspect 19: The method of aspect 18, wherein the second transmit power is less than the transmit power.

Aspect 20: The method of any of aspects 12 through 19, further comprising: transmitting a second control message indicating one or more interference measurements based at least in part on transmitting the control message, wherein receiving the signal further comprises receiving the signal at a second transmit power based at least in part on the one or more interference measurements.

Aspect 21: The method of aspect 20, wherein the second control message includes an indication of one or more grating lobes, the one or more grating lobes based at least in part on receiving the signal via the frequency subband at the transmit power.

Aspect 22: The method of any of aspects 12 through 21, wherein the control message comprises a UCI message or a MAC-CE message.

Aspect 23: An apparatus for wireless communication at a UE, comprising at least one processor; at least one memory coupled with the at least one processor; and instructions stored in the at least one memory and executable by the at least one processor to cause the apparatus to perform a method of any of aspects 1 through 11.

Aspect 24: An apparatus for wireless communication at a UE, comprising at least one means for performing a method of any of aspects 1 through 11.

Aspect 25: A non-transitory computer-readable medium storing code for wireless communication at a UE, the code comprising instructions executable by a processor to perform a method of any of aspects 1 through 11.

Aspect 26: An apparatus for wireless communication at a network entity, comprising at least one processor; at least one memory coupled with the at least one processor; and instructions stored in the at least one memory and executable by the at least one processor to cause the apparatus to perform a method of any of aspects 12 through 22.

Aspect 27: An apparatus for wireless communication at a network entity, comprising at least one means for performing a method of any of aspects 12 through 22.

Aspect 28: A non-transitory computer-readable medium storing code for wireless communication at a network entity, the code comprising instructions executable by a processor to perform a method of any of aspects 12 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor;
at least one memory coupled with the at least one processor; and
instructions stored in the at least one memory and executable by the at least one processor to cause the apparatus to:
transmit a capability message indicating an antenna panel at the UE supports a plurality of frequency subbands of a band;
receive, based at least in part on transmitting the capability message, a control message indicating a power scaling parameter dedicated to a frequency subband of the band for wireless communications by the antenna panel at the UE; and
transmit, by the antenna panel, a signal via the frequency subband at a transmit power that is based at least in part on the power scaling parameter dedicated to the frequency subband.

2. The apparatus of claim 1, wherein the instructions are further executable by the at least one processor to cause the apparatus to:
switch from a second frequency subband of the band to the frequency subband based at least in part on receiving the control message; and
switch from a second power scaling parameter associated with the second frequency subband to the power scaling parameter based at least in part on switching to the frequency subband.

3. The apparatus of claim 2, wherein the frequency subband is a higher frequency than the second frequency subband, and the power scaling parameter indicates increasing the transmit power for transmitting the signal relative to the second power scaling parameter.

4. The apparatus of claim 2, wherein the frequency subband is a lower frequency than the second frequency subband, and the power scaling parameter indicates decreasing the transmit power for transmitting the signal relative to the second power scaling parameter.

5. The apparatus of claim 1, wherein the control message indicates a plurality of power scaling parameters, each power scaling parameter of the plurality of power scaling parameters dedicated to a respective frequency subband of the band.

6. The apparatus of claim 1, wherein the instructions are further executable by the at least one processor to cause the apparatus to:
receive a second control message indicating a modulation and coding scheme dedicated to the frequency subband of the band for wireless communications by the antenna panel at the UE; and
transmit, by the antenna panel, a second signal via the frequency subband using the modulation and coding scheme dedicated to the frequency subband.

7. The apparatus of claim 1, wherein the instructions are further executable by the at least one processor to cause the apparatus to:
receive a second control message indicating an offset associated with the power scaling parameter, wherein transmitting the signal further comprises transmitting the signal at a second transmit power based at least in part on the offset.

8. The apparatus of claim 7, wherein the second transmit power is less than the transmit power.

9. The apparatus of claim 1, wherein the instructions are further executable by the at least one processor to cause the apparatus to:
receive a second control message indicating one or more interference measurements based at least in part on receiving the control message; and
determine an offset associated with the power scaling parameter based at least in part on receiving the second control message, wherein transmitting the signal further comprises transmitting the signal at a second transmit power based at least in part on the offset.

10. The apparatus of claim 9, wherein the second control message includes an indication of one or more grating lobes, the one or more grating lobes based at least in part on transmitting the signal via the frequency subband at the transmit power.

11. The apparatus of claim 1, wherein the control message comprises an uplink control information message or a medium access control-control element (MAC-CE) message.

12. An apparatus for wireless communication at a network entity, comprising:
at least one processor;
at least one memory coupled with the at least one processor; and
instructions stored in the at least one memory and executable by the at least one processor to cause the apparatus to:
receive a capability message indicating an antenna panel at a user equipment (UE) supports a plurality of frequency subbands of a band;
transmit, based at least in part on receiving the capability message, a control message indicating a power scaling parameter dedicated to a frequency subband of the band for wireless communications by the antenna panel at the UE; and
receive, from the antenna panel, a signal via the frequency subband at a transmit power that is based at least in part on the power scaling parameter dedicated to the frequency subband.

13. The apparatus of claim 12, wherein the control message includes an indication to switch from a second frequency subband of the band to the frequency subband and to switch from a second power scaling parameter associated with the second frequency subband to the power scaling parameter.

14. The apparatus of claim 13, wherein the frequency subband is a higher frequency than the second frequency subband, and the power scaling parameter indicates increasing the transmit power for transmitting the signal relative to the second power scaling parameter.

15. The apparatus of claim 13, wherein the frequency subband is a lower frequency than the second frequency subband, and the power scaling parameter indicates decreasing the transmit power for transmitting the signal relative to the second power scaling parameter.

16. The apparatus of claim 12, wherein the control message indicates a plurality of power scaling parameters, each power scaling parameter of the plurality of power scaling parameters dedicated to a respective frequency subband of the band.

17. The apparatus of claim 12, wherein the instructions are further executable by the at least one processor to cause the apparatus to:
transmit a second control message indicating a modulation and coding scheme dedicated to the frequency subband of the band for wireless communications by the antenna panel at the UE; and
receive, by the antenna panel, a second signal via the frequency subband based at least in part on the modulation and coding scheme dedicated to the frequency subband.

18. The apparatus of claim 12, wherein the instructions are further executable by the at least one processor to cause the apparatus to:
transmit a second control message indicating an offset associated with the power scaling parameter, wherein receiving the signal further comprises receiving the signal at a second transmit power based at least in part on the offset.

19. The apparatus of claim 18, wherein the second transmit power is less than the transmit power.

20. The apparatus of claim 12, wherein the instructions are further executable by the at least one processor to cause the apparatus to:
transmit a second control message indicating one or more interference measurements based at least in part on transmitting the control message, wherein receiving the signal further comprises receiving the signal at a second transmit power based at least in part on the one or more interference measurements.

21. The apparatus of claim 20, wherein the second control message includes an indication of one or more grating lobes, the one or more grating lobes based at least in part on receiving the signal via the frequency subband at the transmit power.

22. The apparatus of claim 12, wherein the control message comprises an uplink control information message or a medium access control-control element (MAC-CE) message.

23. A method for wireless communication at a user equipment (UE), comprising:
transmitting a capability message indicating an antenna panel at the UE supports a plurality of frequency subbands of a band;
receiving, based at least in part on transmitting the capability message, a control message indicating a power scaling parameter dedicated to a frequency subband of the band for wireless communications by the antenna panel at the UE; and
transmitting, by the antenna panel, a signal via the frequency subband at a transmit power that is based at least in part on the power scaling parameter dedicated to the frequency subband.

24. The method of claim 23, further comprising:
switching from a second frequency subband of the band to the frequency subband based at least in part on receiving the control message; and
switching from a second power scaling parameter associated with the second frequency subband to the power scaling parameter based at least in part on switching to the frequency subband.

25. The method of claim 23, wherein the control message indicates a plurality of power scaling parameters, each power scaling parameter of the plurality of power scaling parameters dedicated to a respective frequency subband of the band.

26. The method of claim 23, further comprising:
receiving a second control message indicating a modulation and coding scheme dedicated to the frequency subband of the band for wireless communications by the antenna panel at the UE; and
transmitting, by the antenna panel, a second signal via the frequency subband using the modulation and coding scheme dedicated to the frequency subband.

27. The method of claim 23, further comprising:
receiving a second control message indicating an offset associated with the power scaling parameter, wherein transmitting the signal further comprises transmitting the signal at a second transmit power based at least in part on the offset.

28. A method for wireless communication at a network entity, comprising:
receiving a capability message indicating an antenna panel at a user equipment (UE) supports a plurality of frequency subbands of a band;
transmitting, based at least in part on receiving the capability message, a control message indicating a power scaling parameter dedicated to a frequency subband of the band for wireless communications by the antenna panel at the UE; and
receiving, from the antenna panel, a signal via the frequency subband at a transmit power that is based at least in part on the power scaling parameter dedicated to the frequency subband.

29. The method of claim 28, wherein the control message includes an indication to switch from a second frequency subband of the band to the frequency subband and to switch from a second power scaling parameter associated with the second frequency subband to the power scaling parameter.

30. The method of claim 28, wherein the control message indicates a plurality of power scaling parameters, each power scaling parameter of the plurality of power scaling parameters dedicated to a respective frequency subband of the band.
